(19) United States
(12) Patent Application Publication
(10) Pub. No.: US 2026/0164218 A1
(43) Pub. Date: Jun. 11, 2026

(54) METHOD/SYSTEM/COMPUTER PROGRAM FOR DYNAMIC ALLOCATION OF U-NII (UNLICENSED NATIONAL INFORMATION INFRASTRUCTURE) CHANNELS TO DELIVER V2X SERVICES AND MESSAGE EXCHANGE OF V2X SERVICES OVER CELLULAR COMMUNICATION NETWORKS

(71) Applicant: Sonamore, Inc. dba P3Mobility, Ann Arbor, MI (US)

(72) Inventors: Martin Daniel Nathanson, Westmount (CA); Andrew Gilbert Miller, Pittsburgh, PA (US); Jeremy Ward, Denver, CO (US)

(21) Appl. No.: 19/408,840

(22) Filed: Dec. 4, 2025

Related U.S. Application Data
(60) Provisional application No. 63/728,355, filed on Dec. 5, 2024.

(51) Int. Cl. H04W 4/40; H04W 4/029; H04W 4/80; H04W 12/06

(52) U.S. Cl. CPC H04W 4/40; H04W 4/029; H04W 4/80; H04W 12/06

(57) ABSTRACT

A system includes processors programmed or configured to receive Authentication and Authorization (AA) Requests for granting access to V2X services to a duly authenticated and authorized On-board unit (OBU) and to send an AA Response to the OBU. Each AA Request includes (i) the Provider Service Identifiers (PSID) of the requested services, including messages specified in SAE J2735/J3224 or equivalent standards used in non-U.S. jurisdictions and (ii) IEEE 1609.2 credentials enabling authentication and authorization of the OBU. The OBU includes (i) information enabling the OBU to optimize its use of RF bandwidth and (ii) IEEE 1609.2 credentials of the system. The one or more processors are configured or programmed to determine the conditions to be met by the OBU for optimal radiofrequency (RF) bandwidth consumption and to encapsulate the conditions in the payload of the AA Response.

### CROSS-REFERENCE TO RELATED APPLICATIONS

The present application claims priority to U.S. provisional patent application No. 63/728,355 , filed on Dec. 5, 2024, the contents of which are hereby incorporated by reference.

### BACKGROUND

In November 2020, the Federal Communications Commission (FCC) made a decision that repurposed, for unlicensed uses, the lower 45 MHz of the 5.9 GHz Intelligent Transportation Systems (ITS) spectrum allocation dedicated for vehicle-to-vehicle (V2V) and vehicle-to-infrastructure (V2I) safety-critical applications, enabled by V2X (V2X or V2I) services comprising messages compliant with the suite of standards specified in SAE J2735/J3224 or other equivalent or similar standards specified in other international jurisdictions, such as ETSI EN 302 637-2 that is a European standard covering CAM (Cooperative Awareness Message). This decision made it unlikely that the remaining dedicated ITS spectrum is sufficient for all the applications previously envisioned by the automotive industry, in particular sensor data sharing (aka Cooperative Perception) and Cooperative Maneuver. The FCC decision also gave preference to C-V2X over the previously used 802.11p protocol for Dedicated Short Range Communications (aka DSRC) in the remaining ITS spectrum, which could lead to the complete phasing out of DSRC technology in the United States.

The reliability of V2X safety critical applications is dependent on low latency of RF transmission, which means that the spectrum used must be dedicated to ensuring minimal channel contention and concomitant minimal packet loss. The spectrum allocated by a regulatory authority such as the FCC is dedicated for use by devices licensed to participate in the V2X ecosystem by virtue of compliance with the IEEE 1609 (WAVE) communications standards (or similar ETSI standards), such as OBUs (On-board Units) and RSU (Roadside Units). As such, the degree of channel contention due to vehicular volume can be measured and evaluated on test tracks before deployment on the streets. But now that the use of unlicensed spectrum, adjacent to or neighboring the ITS band, is being contemplated as a possible substitute for the spectrum lost by the FCC decision, it is necessary to consider the impact of channel contention from any devices in the vicinity which are non-automotive or unrelated to roadside infrastructure, particularly WiFi-enabled Access Points and consumer electronics such as laptops, tablets and smartphones.

Analogously, the concept of V2X over cellular networks, aka Network V2X, is increasingly seen as an alternative for some safety-critical applications, hitherto confined to the ITS band in order to meet the latency requirements of these applications. Network V2X offers the advantage of obviating the physical roadside infrastructure necessary to service the limited RF transmission range of C-V2X. It is commonly implemented using the MQTT (Message Queuing Telemetry Transport) protocol whereby a message broker operating according to a “publish-subscribe” paradigm, can service an extensive geographic area that would otherwise need a large number of RSUs operating over ITS 5.9. But using Network V2X to lower infrastructure cost has a trade-off in terms of increased RF bandwidth consumption due to a much greater number of devices serviced by an MQTT broker. Minimizing this bandwidth consumption by duly authenticated V2X devices is achieved by a system and methods, as described in this disclosure, which are structurally almost identical to those for minimizing channel contention in the U-NII (Unlicensed National Information Infrastructure) band.

### SUMMARY

The original ITS allocation of 75 MHz was partitioned into 7 channels of 10 MHz width. The WAVE Service Advertisement (WSA) specified in IEEE 1609.3 includes information allowing a receiving OBU to determine which of the 7 channels deliver which V2X services. This information also encompasses other parameters governing the behavior of the Medium Access Control (MAC) layer, as defined by IEEE 802.11p, including data rate, transmit power level and parameters related to distributed channel access mechanisms.

Since C-V2X, which replaces IEEE 802.11p at the MAC layer for devices licensed to operate in the ITS band, uses a channel width of 20 MHz, the spectrum remaining in the band can support only 1 channel. Therefore, the channel identifier, for any service advertised in the WSA operating in the single ITS channel with C-V2X, is now invariant.

However, the channel identifier remains part of the WSA message structure specified in IEEE 1609.3. So, if a service is delivered via an unlicensed channel, the WSA could provide a mechanism to inform receivers which channel is assigned to that service. But since unlicensed spectrum is susceptible to unanticipated channel contention, it may be necessary to frequently switch channels in order to avoid the contention.

However, changing the channel identifier for an advertised service requires a change to the content of the WSA, which in practice cannot be modified without commanding the RSU into a “standby” mode whereby radio communications are disabled while configuration changes are made. For the purposes of real-time operation of V2X services, in most instances the duration of the standby period would not be acceptable. For these reasons, a method of dynamic channel selection is required that operates outside the scope of the RSU functionality specified in IEEE 1609, but in conjunction with services delivered over unlicensed spectrum, advertised in the WSA and identified by IEEE 1609.12 PSIDs (Provider Service Identifiers).

In the case of Network V2X services, changing the MQTT subscription topics for an OBU is analogous to changing the U-NII channel identifier. In Network V2X, RF channel contention increases with each OBU using the same MQTT topic to either publish or subscribe to a V2X message. For example, SAE J2735 SPaT (Signal Phase and Timing) messages are only relevant for an OBU approaching the intersection with the traffic controller from which the SPaT information emanates. So, if all OBU's operating within the service area of an MQTT broker used the same topic to subscribe to messages, it would result in an extremely profligate use of bandwidth. Therefore, the subscription topic should specify the intersection identifier in order to minimize the number of publications that the broker has to issue any OBU subscribing to SPaT. As such, each OBU must cancel its existing subscription and re-subscribe to a new topic as it moves between intersections.

The OBU can discover the identifier of the intersection, in which range it is operating, by subscribing to J2735 MAP messages containing the road geometry for each intersection. But if the OBU has to subscribe to all the MAP messages published by the broker, so that it can use its GPS coordinates to determine in which MAP it currently operates, this is again a profligate use of bandwidth. Bandwidth consumption can again be reduced by minimizing the number of publications that the broker has to issue to any OBU subscribing, this time, to MAP. This is achievable if the OBU continuously changes its MAP subscription using MQTT topics optimized to include only those MAP messages for intersection contiguous to the one in which the OBU is currently located.

The disclosed invention incorporates, by reference in its entirety, U.S. Provisional Patent Application No. 62/357,504 , filed on Jul. 1, 2016, PCT Patent Application PCT/IB2017/053981 filed Jun. 30, 2017, and U.S. Patent Application Ser. No. 15/639,022 filed Jun. 30, 2017, which are incorporated in U.S. Pat. No. 10,187,767, issued on Jan. 22, 2019, U.S. Pat. No. 11,812,349, issued on Nov. 7, 2023, and U.S. Pat. No. 12,375,893, issued on Jul. 29, 2025.

Using a method disclosed in the above referenced related patent applications, OBUs can be informed of the availability of these services, and where further information about their use can be obtained. In the context of the present disclosure, this method enables the OBU to request and receive information that, while it may extend beyond the scope of the WAVE standards, is accessible only to those mobile devices with IEEE 1609.2 credentials. This maximizes the likelihood that use of unlicensed channels, determined to be currently subject to the least contention, is limited to devices licensed for ITS 5.9; networked V2X services using the described method above facilitates efficient use of finite cellular spectrum. Since the present disclosure maintains the same terminology for this method as is used in the related applications, this method is called the Authentication and Authorization Request and Response handshake.

### BRIEF DESCRIPTION OF THE DRAWINGS

The preferred embodiments described herein and illustrated by the drawings hereinafter are included to illustrate and not to limit the invention, where like designations denote like elements.

FIG. 1 illustrates U-NII Monitor and Optimal Channel Information Message Sequence.

FIG. 2 illustrates MQTT Topic Server and Optimal Subscription-Publication Message Sequence.

### DETAILED DESCRIPTION

The following detailed description is merely exemplary in nature and is not intended to limit the described embodiments or the application and uses of the described embodiments. All of the implementations described below are exemplary implementations provided to enable persons skilled in the art to make or use the embodiments of the disclosure and are not intended to limit the scope of the disclosure, which is defined by the claims. It is also to be understood that the drawings included herewith only provide diagrammatic representations of the presently preferred structures of the present invention and that structures falling within the scope of the present invention may include structures different than those shown in the drawings.

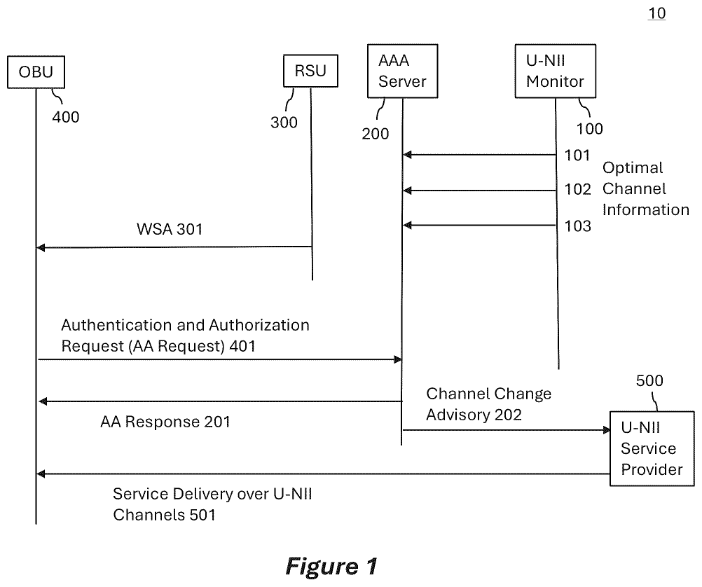

With reference to FIG. 1, shown is a diagram that illustrates U-NII Monitor and Optimal Channel Information Message Sequence. The disclosed invention discloses system 10 that monitors all 802.11 protocol type traffic transmitted over unlicensed spectrum where DSRC (802.11p) traffic may be used, in order to determine the channel with least congestion and/or contention to DSRC participant traffic. The system incorporates a radio receiver module and accompanying antenna(s) and is operable to monitor 802.11 type activity in unlicensed spectrum channels where DSRC (802.11p) traffic may be used, shown as U-NII Monitor 100 in FIG. 1. Upon determining the optimal channel for use, the system 10 may dynamically manage the channel that participant DSRC users should use. It is to be understood that U-NII Monitor 100 may be instantiated as a user process running independently within an RSU equipped with the requisite radio receiver module dedicated for monitoring the U-NII (Unlicensed National Information Infrastructure) bands neighboring the ITS band.

Upon receiving the 802.11 radio transmissions of other 802.11 transmitters within range and for a given sample period, U-NII Monitor 100 maintains an aggregate count of packets and/or bytes sent over the monitored channels and, with a combination that may include one or more models and/or algorithms, determines or predicts the optimal channel to use at the current time and/or future time, that provides the least amount of channel contention or congestion. In some embodiment one or more employed models may make use of weighted historical channel traffic patterns accounting for example weekday vs. weekend, day of week and/or time of day. Following determination of the current or future time optimal channel, as shown in FIG. 1, the optimal channel information 101-103 is sent to AAA (Authentication, Authorization and Accounting) Server 200 for successive sample periods.

The actual delivery of services over unlicensed spectrum (Service Delivery over U-NII Channels 501) is carried out by U-NII Service Provider 500. The preferred embodiment of U-NII Service Provider 500 is a process running within the core operating system (typically Linux) of an RSU enabled with a DSRC radio. The services are advertised by the RSU 300 in WSA 301, in accordance with IEEE 1609.3. WSA 301 may specify a default channel identifier but this will be subject to change whenever U-NII Monitor 100 identifies a more optimal channel. To receive the latest optimal channel information, and in accordance with the methods disclosed in the related applications, OBU 400 sends Authentication and Authorization Request (AA Request) 401 to AAA Server 200. The Authentication and Authorization (AA Response) 201 may encapsulate a Channel Change Coordination Message that may include but is not limited to the channel identifier, cryptographic key for channel traffic, and the time that the change goes into effect. AAA Server 200 also sends Channel Change Advisory 202 to U-NII Service Provider 500, instructing it to switch, at the time set for channel change, to transmit and receive on the updated channel along with any applicable other updates (e.g. cryptographic key change).

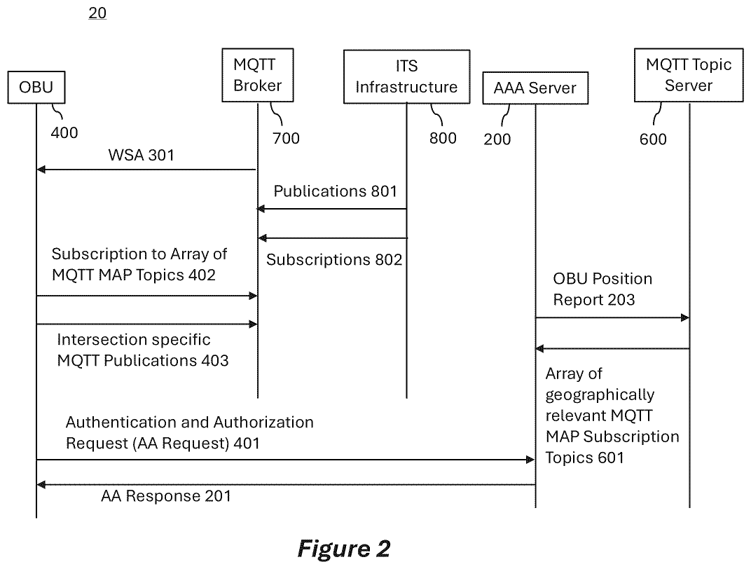

With reference to FIG. 2, shown is a diagram that illustrates MQTT Topic Server and Optimal Subscription-Publication Message Sequence. System 20 shown in FIG. 2, similar to that described above for U-NII, can be defined for optimization of bandwidth consumption in Network V2X, illustrated in FIG. 2. In this instance, the MQTT message broker 700 is analogous to the RSU 300 of FIG. 1 and the MQTT topic server 600 is analogous to the U-NII Monitor 100 of FIG. 1. Messages originating in ITS infrastructure, exemplified by the ITS Infrastructure component 800, are published with an infrastructure-specific topic that identifies, for instance, an intersection identifier (Publications) 801. As well, the ITS Infrastructure component 800 subscribes to infrastructure-specific topics (Subscriptions) 802.

The AA Request 401 from the OBU 400 incorporates a Global Navigation Satellite System (GNSS)-derived position report (OBU Position Report 203) that the MQTT topic server 600 uses to identify the array of geographically relevant MAP messages (Array of geographically relevant MQTT MAP Subscription Topics 601) to which the OBU 400 should subscribe, where geographic relevance may be determined by proximity, past and/or predicted areas of travel, speed and/or dwell time in one area before entering the geographic area and/or specific intersections and/or specific service type topics covered by another message broker topic group. This information is returned to the OBU 400 in the payload of the AA Response 201. The OBU 400 then performs (i) subscribing to the geographically relevant MAP messages 402, (ii) determining the intersection identifier corresponding to its current location, (iii) subscribing to any other messages originating in the infrastructure (e.g. SPaT) using an infrastructure-specific topic 402, (iv) publishing its Basic Safety Messages and other mobile-originated messages 403 using an infrastructure-specific topic.

Since many modifications, variations, and changes in detail can be made to the described preferred embodiments of the invention, it is intended that all matters in the foregoing description and shown in the accompanying drawings be interpreted as illustrative and not in a limiting sense. Consequently, the scope of the invention should be determined by the appended claims and their legal equivalents.

What is claimed is:

1. A system comprising:
one or more processors programmed or configured to:
receive Authentication and Authorization (AA) Requests, for granting access to V2X services to a duly authenticated and authorized On-board unit (OBU), wherein each AA Request comprises:
the Provider Service Identifiers (PSID) of the requested services comprising messages specified in SAE J2735/J3224 or equivalent standards used in non-U.S. jurisdictions, and
IEEE 1609.2 credentials enabling authentication and authorization of said OBU; and
send an AA Response to said OBU comprising:
information enabling said OBU to optimize its use of RF bandwidth, and
IEEE 1609.2 credentials of said system;
wherein the one or more processors are configured or programmed to determine the conditions to be met by said OBU for optimal radiofrequency (RF) bandwidth consumption and to encapsulate said conditions in the payload of said AA Response,
where the V2X services are vehicle-to-vehicle (V2V) or vehicle-to-infrastructure (V2I) services.

2. The system of claim 1, wherein the one or more processors are further programmed or configured to:
include the Global Navigation Satellite System (GNSS) derived position of said OBU in said AA Request; and
determine one or more specific message broker topic groups to which an authorized OBU is assigned for the optimization of bandwidth consumption in Networked V2X over cellular carrier networks, wherein said OBU's GNSS position is used to determine the down selection to geographic relevant message broker topic groups to which said OBU should be joined for publishing and/or subscribing, wherein the determined one or more specific message broker topic groups information is encapsulated in the payload of said AA Response sent to said OBU which in turn is able to actively receive or subscribe to messages and/or transmit or publish messages to the topic via the message broker;
wherein subsequent AA Requests containing the GNSS positions of said OBU requesting continued access to V2X services are used to determine one or more applicable message broker topic groups from or with which said OBU should drop, continue or join, wherein upon validating authorization for requested services a response message is generated containing the one or more applicable message broker topic groups that said OBU should join next and the message is transmitted to the requester.

3. The system of claim 1, wherein the one or more processors are further programmed or configured to:
determine the optimal unlicensed radio channel to use for 802.11p Dedicated Short Range Communications (DSRC); and
count the number of received packets and/or bytes in the 802.11 protocol channels over various time period samples,
wherein these sample periods may overlap other sample periods or be distinct from other sample periods, to determine the 802.11 protocol type traffic throughput and rate of data throughput in the 802.11 protocol channels in unlicensed spectrum,
wherein the throughput and/or rate throughput values are factors to determine the radio channel that currently or is predicted to in the future experience the least amount of channel contention and/or congestion; wherein the determination of radio channel with lowest contention and/or congestion may be determined by, but is not limited to, use of heuristic weighted models and/or algorithms that infer current and future RF channel traffic congestion and contention patterns,
wherein the models and/or algorithms in addition to the sampled channel packet/byte traffic may use input factors such as time of day, workday vs non-workday, weather, adjacent RF channel activity, and road vehicular traffic activity,
wherein determination is made of the output inference of the model(s) and/or algorithms to determine which radio channel to use for system DSRC traffic,
wherein the information about the determined optimal channel is formatted into a Channel Change Coordination Message (CCCM), wherein the CCCM is encapsulated in the payload of said AA Response sent to said OBU, wherein the generated Channel Change Coordination Message may include but is not limited to the channel identifier, cryptographic key for channel traffic, and the time that the change goes into effect, wherein the latest channel in use will have a into effect time already past, wherein the participant joined on the radio channel may receive a Channel Change Coordination Message with a future channel change effective time of a future date-time group, wherein the system may periodically and/or on an ad-hoc basis and/or on the merits of other conditions change the radio channel and/or the cryptographic key used to secure the traffic on the radio channel, wherein the information of Channel Change Coordination Message is sent to the controller of the DSRC radio transceiver device to instruct the switch to the selected radio channel and/or updated cryptographic key at the time indicated in the Channel Change Coordination Message.

4. A method comprising:
receiving Authentication and Authorization (AA) Requests, for granting access to V2X services to a duly authenticated and authorized On-board unit (OBUs), wherein each AA Request comprises:
the Provider Service Identifiers (PSID) of the requested services comprising messages specified in SAE J2735/J3224 or equivalent standards used in non-U.S. jurisdictions, and
IEEE 1609.2 credentials enabling authentication and authorization of said OBU; and
sending an AA Response to said OBU comprising:
information enabling said OBU to optimize its use of RF bandwidth, and
IEEE 1609.2 credentials of said system;
wherein the one or more processors are configured or programmed to determine the conditions to be met by said OBU for optimal radiofrequency (RF) bandwidth consumption and to encapsulate said conditions in the payload of said AA Response,
where the V2X services are vehicle-to-vehicle (V2V) or vehicle-to-infrastructure (V2I) services.

5. The method of claim 4, further comprising:
including the Global Navigation Satellite System (GNSS) derived position of said OBU in said AA Request; and
determining one or more specific message broker topic groups to which an authorized OBU is assigned for the optimization of bandwidth consumption in Networked V2X over cellular carrier networks, wherein said OBU's GNSS position is used to determine the down selection to geographic relevant message broker topic groups to which said OBU should be joined for publishing and/or subscribing, wherein the determined one or more specific message broker topic groups information is encapsulated in the payload of said AA Response sent to said OBU which in turn is able to actively receive or subscribe to messages and/or transmit or publish messages to the topic via the message broker;
wherein subsequent AA Requests containing the GNSS positions of said OBU requesting continued access to V2X services are used to determine one or more applicable message broker topic groups from or with which said OBU should drop, continue or join, wherein upon validating authorization for requested services a response message is generated containing the one or more applicable message broker topic group(s) that said OBU should join next and the message is transmitted to the requester.

6. The method of claim 4, further comprising:
determining the optimal unlicensed radio channel to use for 802.11p Dedicated Short Range Communications (DSRC); and
counting the number of received packets and/or bytes in the 802.11 protocol channels over various time period samples,
wherein these sample periods may overlap other sample periods or be distinct from other sample periods, to determine the 802.11 protocol type traffic throughput and rate of data throughput in the 802.11 protocol channels in unlicensed spectrum,
wherein the throughput and/or rate throughput values are factors to determine the radio channel that currently or is predicted to in the future experience the least amount of channel contention and/or congestion; wherein the determination of radio channel with lowest contention and/or congestion may be determined by, but is not limited to, use of heuristic weighted models and/or algorithms that infer current and future RF channel traffic congestion and contention patterns,
wherein the models and/or algorithms in addition to the sampled channel packet/byte traffic may use input factors such as time of day, workday vs non-workday, weather, adjacent RF channel activity, and road vehicular traffic activity,
wherein determination is made of the output inference of the model(s) and/or algorithms to determine which radio channel to use for system DSRC traffic,
wherein the information about the determined optimal channel is formatted into a Channel Change Coordination Message (CCCM), wherein the CCCM is transmitted to the participant, wherein the generated Channel Change Coordination Message may include but is not limited to the channel identifier, cryptographic key for channel traffic, and the time that the change goes into effect, wherein the latest channel in use will have a into effect time already past, wherein the participant joined on the radio channel may receive a Channel Change Coordination Message with a future channel change effective time of a future date-time group, wherein the system may periodically and/or on an ad-hoc basis and/or on the merits of other conditions change the radio channel and/or the cryptographic key used to secure the traffic on the radio channel, wherein the information of Channel Change Coordination Message is sent to the controller of the DSRC radio transceiver device to instruct the switch to the selected radio channel and/or updated cryptographic key at the time indicated in the Channel Change Coordination Message.

7. At least one non-transitory computer readable medium storing at least one computer program product that comprises one or more instructions that cause at least one processor to perform operations, comprising:
receiving Authentication and Authorization (AA) Requests, for granting access to V2X services to a duly authenticated and authorized On-board unit (OBUs), wherein each AA Request comprises:
the Provider Service Identifiers (PSID) of the requested services comprising messages specified in SAE J2735/J3224 or equivalent standards used in non-U.S. jurisdictions, and
IEEE 1609.2 credentials enabling authentication and authorization of said OBU; and
sending an AA Response to said OBU comprising:
information enabling said OBU to optimize its use of RF bandwidth, and
IEEE 1609.2 credentials of said system;
wherein the one or more processors are configured or programmed to determine the conditions to be met by said OBU for optimal radiofrequency (RF) bandwidth consumption and to encapsulate said conditions in the payload of said AA Response,
where the V2X services are vehicle-to-vehicle (V2V) or vehicle-to-infrastructure (V2I) services.

8. The at least one non-transitory computer readable medium of claim 7, the operations further comprising:
including the Global Navigation Satellite System (GNSS) derived position of said OBU in said AA Request; and
determining one or more specific message broker topic groups to which an authorized OBU is assigned for the optimization of bandwidth consumption in Networked V2X over cellular carrier networks, wherein said OBU's GNSS position is used to determine the down selection to geographic relevant message broker topic groups to which said OBU should be joined for publishing and/or subscribing, wherein the determined one or more specific message broker topic groups information is encapsulated in the payload of said AA Response sent to said OBU which in turn is able to actively receive or subscribe to messages and/or transmit or publish messages to the topic via the message broker;
wherein subsequent AA Requests containing the GNSS positions of said OBU requesting continued access to V2X services are used to determine one or more applicable message broker topic groups from or with which said OBU should drop, continue or join, wherein upon validating authorization for requested services a response message is generated containing the one or more applicable message broker topic groups that said OBU should join next and the message is transmitted to the requester.

9. The at least one non-transitory computer readable medium of claim 7, the operations further comprising:
determining the optimal unlicensed radio channel to use for 802.11p Dedicated Short Range Communications (DSRC); and
counting the number of received packets and/or bytes in the 802.11 protocol channels over various time period samples,
wherein these sample periods may overlap other sample periods or be distinct from other sample periods, to determine the 802.11 protocol type traffic throughput and rate of data throughput in the 802.11 protocol channels in unlicensed spectrum,
wherein the throughput and/or rate throughput values are factors to determine the radio channel that currently or is predicted to in the future experience the least amount of channel contention and/or congestion; wherein the determination of radio channel with lowest contention and/or congestion may be determined by, but is not limited to, use of heuristic weighted models and/or algorithms that infer current and future RF channel traffic congestion and contention patterns,
wherein the models and/or algorithms in addition to the sampled channel packet/byte traffic may use input factors such as time of day, workday vs non-workday, weather, adjacent RF channel activity, and road vehicular traffic activity,
wherein determination is made of the output inference of the model(s) and/or algorithms to determine which radio channel to use for system DSRC traffic,
wherein the information about the determined optimal channel is formatted into a Channel Change Coordination Message (CCCM), wherein the CCCM is transmitted to the participant, wherein the generated Channel Change Coordination Message may include but is not limited to the channel identifier, cryptographic key for channel traffic, and the time that the change goes into effect, wherein the latest channel in use will have a into effect time already past, wherein the participant joined on the radio channel may receive a Channel Change Coordination Message with a future channel change effective time of a future date-time group, wherein the system may periodically and/or on an ad-hoc basis and/or on the merits of other conditions change the radio channel and/or the cryptographic key used to secure the traffic on the radio channel, wherein the information of Channel Change Coordination Message is sent to the controller of the DSRC radio transceiver device to instruct the switch to the selected radio channel and/or updated cryptographic keys at the time indicated in the Channel Change Coordination Message.
